(19) United States
(12) Patent Application Publication
(10) Pub. No.: US 2015/0199900 A1
(43) Pub. Date: Jul. 16, 2015

(54) Display Device

(71) Applicant: Top Victory Investments Ltd., Kowloon (HK)

(72) Inventor: Hung-Wang Hsu, New Taipei City (TW)

(73) Assignee: Top Victory Investments Ltd., Kowloon (HK)

(21) Appl. No.: 14/151,958

(22) Filed: Jan. 10, 2014

(51) Int. Cl. G08C 23/04

(52) U.S. Cl. CPC G08C 23/04

(57) ABSTRACT

The present invention provides a display device comprising a display module, a wireless remote control device, a housing body, and a package body. The housing body surrounds the display module and includes a through hole penetrating through the housing body. The package body comprises a circuit component, a first and a second lighting unit. The circuit component electrically connects to the display module. The first and the second lighting units electrically connect to the circuit component. Wherein, the first lighting unit emits invisible light, the second lighting unit emits visible light, the first and the second lighting units align with the through hole, and the wireless remote control device is capable of receiving light emitted from the first lighting unit. Comparing to the prior art, the present invention has better aesthetic of the display device, and the display device can be made smaller and thinner.

### BACKGROUND OF THE INVENTION

1. Field of the Invention

The present invention relates to a display device, and more particularly, to a display device capable of surveying internet.

2. Description of the Prior Art

According to improvements of semiconductor components, network communication, and other technology, there are more and more display devices having multiple functions capable of not only playing videos but also surveying internet, such as smart TV. The display devices usually include a powerful operating system which can be utilized for surveying internet, downloading applications (apps), and operating as same as using a computer.

According to demands of operations above-mentioned, these display devices need to provide convenient control means such as a cursor capable of controlling, and also provide a wireless remote control device capable of controlling the cursor. According to the prior art, positions and movements of the cursor can be determined by means of installing an infrared transmitter on the display device matching an infrared positioning module disposed on the wireless remote control device to apply the wireless remote control device to derive a positioning reference point by the infrared transmitter, so as to satisfy the purpose of controlling the cursor in a wireless manner. Wherein an installing position of the infrared transmitter is corresponding to a through hole disposed on a housing body of the display device; however, there are more through holes disposed on the housing body and corresponding to different indicating signals, such as power on/off indicating signals. The more the through holes on the housing body, the worse the aesthetic of the display device is.

In addition, there is a bi-color light emitting diode (LED) which is a single LED component having a single lead-frame including two LED chips disposed on the lead-frame. Light emitted from the two LED chips have different colors but both are visible. An installing position of the bi-color LED is corresponding to a single through hole on a housing body of a display device, but the bi-color LED can only utilized for indicating signals, such as red light for indicating power off and green light for indicating power on. For the purpose of positioning, an infrared transmitter is still needed to install in addition. Infrared for positioning and visible light for indicating signals require different LED components to emit which require more space in the display device, such that the display device is hard to be made smaller and thinner, and the more components the display device has, the more the cost is; therefore, prior display devices have not provided any suitable solutions yet.

### SUMMARY OF THE INVENTION

According to the shortage of the prior art, the present invention aims to provide a display device, so as to reduce requirements of space in the display device, decrease the amount of through holes and components, and reduce the cost.

According to the claimed invention, the display device comprises a display module, a wireless remote control device, a housing body, and a package body. The housing body surrounds the display module and includes a through hole penetrating through the housing body. The package body comprises a circuit component, a first lighting unit, and a second lighting unit. The circuit component electrically connects to the display module. The first and the second lighting units electrically connect to the circuit component. Wherein, the first lighting unit emits invisible light, the second lighting unit emits visible light, the first and the second lighting units align with the through hole, and the wireless remote control device is capable of receiving light emitted from the first lighting unit.

According to an embodiment of the claimed invention, the package body is a single light emitting diode component, the first and the second lighting units are light emitting diode chips, and the circuit component is a lead-frame.

According to the embodiment of the claimed invention, light emitted from the first lighting unit is infrared, and light emitted from the second lighting unit is utilized for indicating a signal.

According to the embodiment of the claimed invention, the wireless remote control device includes a cursor control module, and the cursor control module can position by utilizing of light emitted from the first lighting unit.

According to the embodiment of the claimed invention, the wireless remote control device further includes an infrared positioning module, and the infrared positioning module is utilized for receiving light emitted from the first lighting unit.

According to the embodiment of the claimed invention, the infrared positioning module includes an infrared sensor.

The display device of the present invention reduces requirements of space occupied by relative components in the display device, and decrease the amount of through holes by integrating the first and the second lighting units to dispose on the same circuit component and seal in the same package body and aligning the first and the second lighting units with the single through hole. Comparing to the prior art, the present invention has better aesthetic of the display device, and the display device can be made smaller and thinner. In addition, comparing to the bi-color LED, the present invention utilizes the single LED component to emit either visible light or invisible light so as to decrease the amount of components, and reduce the cost.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a display device according to a preferred embodiment of the present invention.

FIG. 2 is a diagram of the display device according to the preferred embodiment of the present invention.

FIG. 3 is a sectional enlarge diagram of the display device according to the preferred embodiment of the present invention.

### DETAILED DESCRIPTION

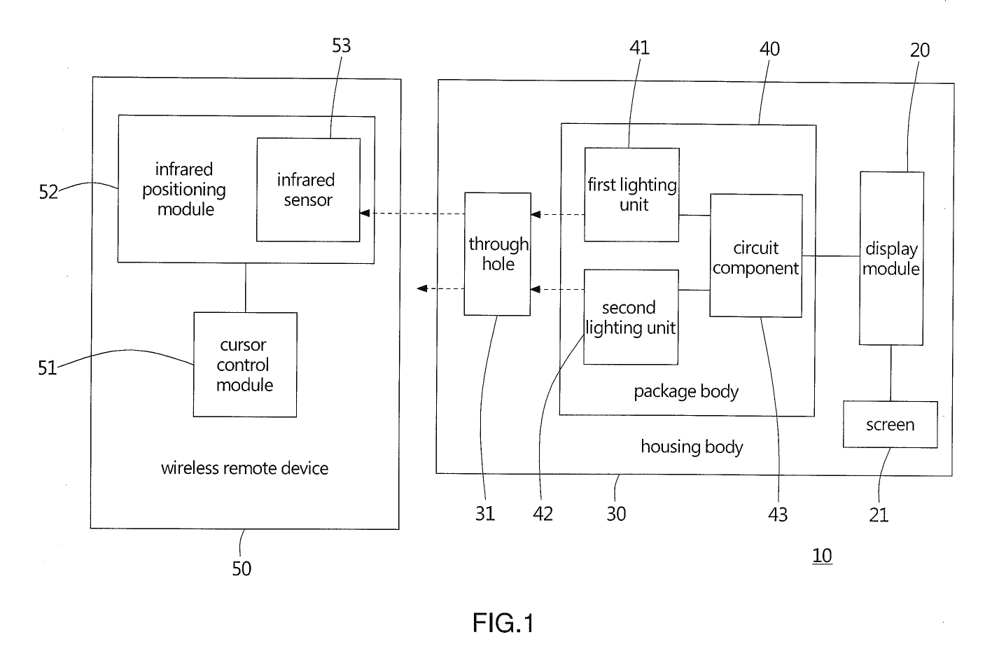

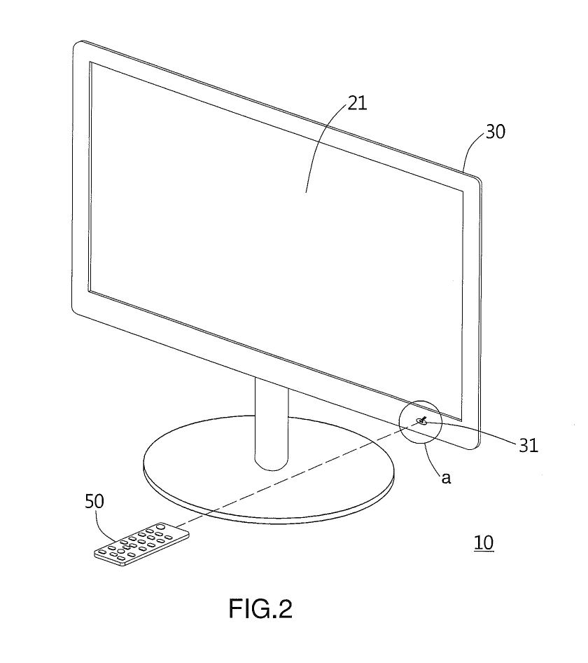

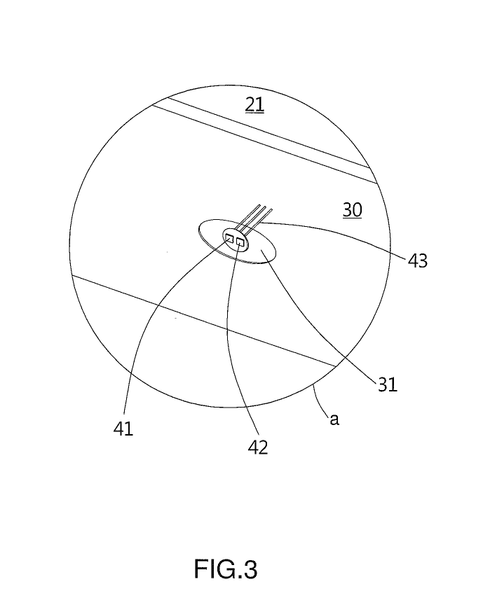

Please refer to FIG. 1 to FIG. 3. FIG. 1 depicts a block diagram of a display device according to a preferred embodiment of the present invention. FIG. 2 depicts a diagram of the display device according to the preferred embodiment of the present invention. FIG. 3 depicts a sectional enlarge diagram of the display device according to the preferred embodiment of the present invention. A display device 10 is a smart TV which includes but not limit to a function of surveying internet. The display device 10 comprises a display module 20, a housing body 30, a package body 40, and a wireless remote control device 50. The housing body 30 surrounds the display module 20. A front side of the housing body 30 exposes a screen 21 of the display module 20, and a through hole 31 is disposed on and penetrates through the front side of the housing body 30.

The package body 40 comprises a first lighting unit 41, a second lighting unit 42, and a circuit component 43. The package body 40 is a single light emitting diode (LED) component. In the embodiment, the first and the second lighting units 41, 42 are light emitting diode chips (LED chips), and the circuit component 43 is a lead-frame. The circuit component 43 electrically connects to the display module 20. The first lighting unit 41 and the second lighting unit 42 are fixed to the same circuit component 43 and electrically connect to the circuit component 43. Preferably, the first and the second lighting units 41, 42 can be covered by resin. The package body 40 is fixed to a position behind the through hole 31, and the first and the second lighting units 41, 42 are positioned in the through hole 31. The point is that the first lighting unit 41 emits invisible light, and the second lighting unit 42 emits visible light; in other words, the package body 40 as the single LED component can emit not only visible light but also invisible light.

Further, as shown in FIG. 3, the first and the second lighting units 41, 42 are close to each other. Preferably, the first and the second lighting units 41, 42 are adjacent to each other, and the first and the second lighting units 41, 42 align with the through hole 31. In a front view of the display device 10, where the sight of the user watching the display device 10 aligns with a direction of normal line of the screen 21, the first and the second lighting units 41, 42 both project in the range of the opening of the through hole 31.

In another embodiment, a first lighting unit can emit visible light instead of invisible light and a second lighting unit can emit invisible light accordingly. In the preferred embodiment, light emitted from the first lighting unit 41 is infrared, and light emitted from the second lighting unit 42 is utilized for indicating a signal. For example, the second lighting unit 42 can be a power on/off indicator or other indicator. The reason that light emitted from the second lighting unit 42 is needed to be visible is to make sure that human eyes can recognize the light so as to utilize it for indicating.

The wireless remote control device 50 corresponds to the first lighting unit 41. More specifically, the wireless remote control device 50 can be positioned by utilizing of light emitted from the first lighting unit 41 and can further derive the corresponding correlation between a cursor which is displayed on the screen 21 of the display module 20 and the wireless remote control device 50; therefore, users can use the wireless remote control device 50 to control the cursor so as to survey Internet on the display device 10 easily or operate an operating system and applications of the display device 10. The wireless remote control device 50 includes a cursor control module 51 and an infrared positioning module 52. The infrared positioning module 52 includes an infrared sensor 53. More specifically, the infrared positioning module 52 is corresponding to the first lighting unit 41. The infrared sensor 53 is utilized for receiving and sensing an infrared emitted from the first lighting unit 41. The infrared positioning module 52 positions by comparing a spatial coordinates of the first lighting unit 41, further cooperates with the cursor control module 51 to process a positioning data, and then transmits signals with regard to the positioning data in a wireless manner to the display module 20, so as to move the cursor displayed on the screen 21 accordingly.

In another embodiment, light emitted from a first lighting unit is not limit to infrared, and light utilized for positioning performed by a positioning module and a sensor of a wireless remote control device are not limit to infrared, too. For example, the first lighting unit can be a blue LED chip, and the corresponding sensor is sensitive to the wavelength of blue rays emitted from the first lighting unit, such that the positioning module can position by blue rays emitted from the first lighting unit. The point is that light emitted from the first lighting unit cannot affect the vision of user and the indicating effect of the second lighting unit; therefore, light utilized for positioning prefers to be invisible light.

In conclusion, the display device that the present invention disclosed integrates the first and the second lighting units to dispose on the same circuit component and seal in the same package body and makes the first and the second lighting units align with the single through hole. Because the single LED component and the single through hole on the display device have different functions (capable of emitting light for positioning and indicating), the present invention reduces requirements of space occupied by relative components in the display device and decrease the amount of through holes penetrating through the housing body. Comparing to the prior art, the present invention has better aesthetic of the display device, and the display device can be made smaller and thinner. In addition, comparing to the prior bi-color LED capable of emitting visible light with different color, the present invention utilizes the single LED component to emit either visible light or invisible light for both indicating and positioning, so as to decrease the amount of components and reduce the cost.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A display device comprising:
a display module;
a wireless remote control device;
a housing body surrounding the display module and including a through hole penetrating through the housing body; and
a package body comprising:
a circuit component electrically connecting to the display module;
a first lighting unit electrically connecting to the circuit component; and
a second lighting unit electrically connecting to the circuit component,
wherein, the first lighting unit emits invisible light, the second lighting unit emits visible light, the first and the second lighting units align with the through hole, and the wireless remote control device receives light emitted from the first lighting unit.

2. The display device of claim 1, wherein the package body is a single light emitting diode component, the first and the second lighting units are light emitting diode chips, and the circuit component is a lead-frame.

3. The display device of claim 1, wherein light emitted from the first lighting unit is infrared, and light emitted from the second lighting unit is utilized for indicating a signal.

4. The display device of claim 1, wherein the wireless remote control device includes a cursor control module, and the cursor control module positions by utilizing of light emitted from the first lighting unit.

5. The display device of claim 4, wherein the wireless remote control device further includes an infrared positioning module, and the infrared positioning module is utilized for receiving light emitted from the first lighting unit.

6. The display device of claim 5, wherein the infrared positioning module includes an infrared sensor.
